(19) United States
(12) Patent Application Publication
(10) Pub. No.: US 2005/0057578 A1
(43) Pub. Date: Mar. 17, 2005

(54) Digital photo frame

(76) Inventors: Shan-Jang Chen, Jubei City (TW); Chang-Wei Lin, Jubei City (TW); Pao-Chyuan Chen, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/662,286

(22) Filed: Sep. 16, 2003

(51) Int. Cl. G09G 5/00

(52) U.S. Cl. 345/630

(57) ABSTRACT

A digital photo frame comprises a storage unit for storing various picture data and music data. A built-in control software can be used to select a matching music and a matching digital outer frame pattern for each picture. When displaying a different picture, the matching music can be played and the matching digital outer frame pattern can be displayed automatically. Through the sound recording function, a matching music can be recorded for each picture. The alarm clock function and the radio reception function can also be added into this digital photo frame. With the control software, the time display format and position can be set. The music to be played can also be selected for the alarm clock. Through the digital photo frame, a user can select the picture and the outer frame pattern to be displayed and the music to be played according to his mood and liking.

### FIELD OF THE INVENTION

The present invention relates to a digital photo frame and, more particularly, to a digital photo frame, which can set matching music and digital outer frame patterns for different pictures and can record matching music for pictures.

### BACKGROUND OF THE INVENTION

Placing one's family members on the desk and viewing them at leisure times to recover the morale and change the mood is a common thing. A delicate photo frame matched with a memorable photograph or a scenery photograph not only has the usage of appreciation, but is also part of decoration in the living space.

Thanks to the science and technology, compact and low power-consumption displays have been popular gradually. A digital photo frame made of a display has a memory capable of storing several photographs, and can quickly change the photograph to be displayed. A digital photograph taken by a digital still camera and then stored into the memory in the digital photo frame can be displayed without the need of printing out the photograph. A user can arbitrarily change the displayed photograph according to his liking, which can't be accomplished with a conventional photo frame. However, a digital photo frame combined with the electronic technology for simply displaying photographs can't keep up with the trend in this digital age.

Accordingly, the present invention aims to propose a digital photo frame having several variations to provide more added functions for users, thereby increasing the practicality and added value of the digital photo frame.

### SUMMARY AND OBJECTS OF THE PRESENT INVENTION

The primary object of the present invention is to provide a multi-function digital photo frame, which can set a matching music for each displayed photograph.

Another object of the present invention is to provide a digital photo frame whose outer frame pattern can be arbitrarily changed.

Yet another object of the present invention is to provide a digital photo frame capable of recording a matching music for the displayed photograph.

Still yet another object of the present invention is to provide a digital photo frame combined with the alarm clock function to display the time information on a digital outer frame of the digital photo frame.

To achieve the above objects, the present invention proposes a digital photo frame, which comprises a storage unit, a digital processing unit, a display unit, a sound reception and playback unit, a control software and a control input unit. The storage unit can be a storage medium like a flash memory or a memory card, and is used for storing picture and music data. The digital processing unit can decompress and decode pictures of several compression formats, and can also compress and decompress music data. The display unit is used for displaying picture data decoded by the digital processing unit and digital outer frame patterns of the digital photo frame. The sound reception and playback unit is used to receive sound and record the received sound into digital music data through the digital processing unit and store this digital music data into the storage unit. The sound reception and playback unit can play music data decompressed by the digital processing unit. The control software is stored in the storage unit and executed by the digital processing unit. This control software can select a picture to be displayed from the storage unit and set a matching music for each picture, and can automatically play the matching music according to the displayed picture. This control software can also record a matching music for a specific picture. The digital outer frame pattern to be displayed can also be selected through this control software. The control input unit is arranged on the outer frame surface of the digital photo frame. A user can operate the control software through this control input unit to control the digital photo frame.

In another embodiment of the present invention, a time unit is added in the above digital photo frame to generate the present time information, which can be displayed by the display unit. The control software can control the time display position and format, and can set a specific time for playing music, i.e., having the alarm clock function.

The various objects and advantages of the present invention will be more readily understood from the following detailed description when read in conjunction with the appended drawings, in which:

### BRIEF DESCRIPTION OF DRAWINGS

FIG. 1 is an internal architecture diagram of a digital photo frame of the present invention;

FIG. 2 is a diagram showing that a digital photo frame displays a picture and a digital outer frame pattern; and

FIG. 3 is a diagram showing the present time information are displayed on a digital outer frame pattern of a digital photo frame of the present invention.

### DETAILED DESCRIPTION OF PREFERRED EMBODIMENT

Along with the progress of the science and technology, conventional monotonous photo frames have been gradually replaced by digital photo frames. The present invention aims to provide a digital photo frame including various functions for enhancing fun in lives.

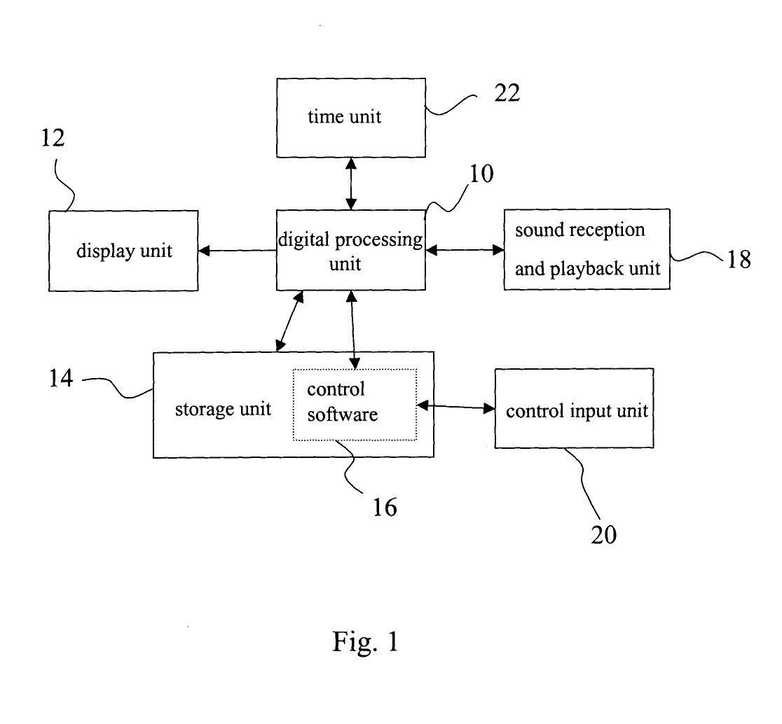

In order to let a digital photo frame have more functions, a multi-function digital processing unit 10 is added in the digital photo frame of the present invention. The digital processing unit 10 has a hardware compression/decompression function, and can process common picture and sound formats like GIF and JPEG picture formats and WAV and MP3 formats. As shown in FIG. 1, the digital photo frame uses the digital processing unit 10 as the center, and connects a storage unit 14, a display unit 12, a sound reception and playback unit 18 and a control software 16 stored in the storage unit 14. The digital photo frame operates the built-in control software 16 through a control input unit 20 to perform each function of the digital thereof.

The storage unit 14 is used for storing picture and music data and the control software 16. The storage unit 14 can be a built-in flash memory or a memory card access device. A user can directly use common memory cards like CF cards, MS cards, MMC cards, SM cards, SD cards, XD cards or microdrives. The control software 16 can also be stored in a read only memory (ROM) so that the user needs not to worry about the duplication problem of the control software when replacing a different memory card.

The display unit 12 is used to receive and display picture data decompressed by the digital processing unit 10, and can display a digital outer frame pattern 26. The display unit 12 is a compact and low power-consumption display, and can be a liquid crystal display, a plasma display panel, an organic light emitting device or a field emission device. The sound reception and playback unit 18 of the digital photo frame is composed of a microphone and a loudspeaker, and is used to receive sound and play music decompressed by the digital processing unit 10. In order to facilitate operation of each function of the digital photo frame, a control input unit 20 composed of several keys is arranged on the outer frame of the digital photo frame. The control input unit 20 can operate the built-in control software 16 to control the function of the digital photo frame.

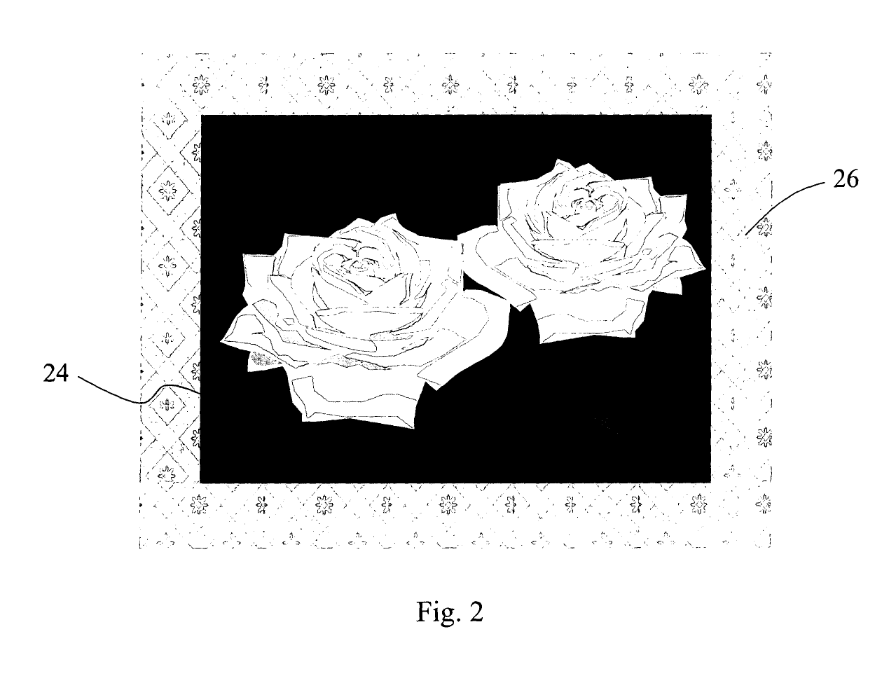

The digital photo frame of the present invention uses the built-in digital processing unit 10 and control software 16 to let a user set a matching music for each picture stored in the storage unit 14. When the digital photo frame displays a picture already having a matching music, the set music will be played automatically. Besides, the microphone of the sound reception and playback unit 18 can be used for recording a matching music for a picture and converting the recorded music into digital music data through the digital processing unit 10. The digital music data can be stored in the storage unit 14 for repetitive playback. The digital photo frame of the present invention has also a digital outer frame function. As shown in FIG. 2, the display unit 12 not only can display a picture 24, but also can display a changeable digital outer frame pattern 26 at the periphery of the picture 24. A user can set different outer frame patterns for different patterns himself. The digital photo frame not only has the function of setting the matching music, but also can set a different digital outer frame pattern 26 for each picture to let the digital photo frame have more complete functions to meet various requirements of users.

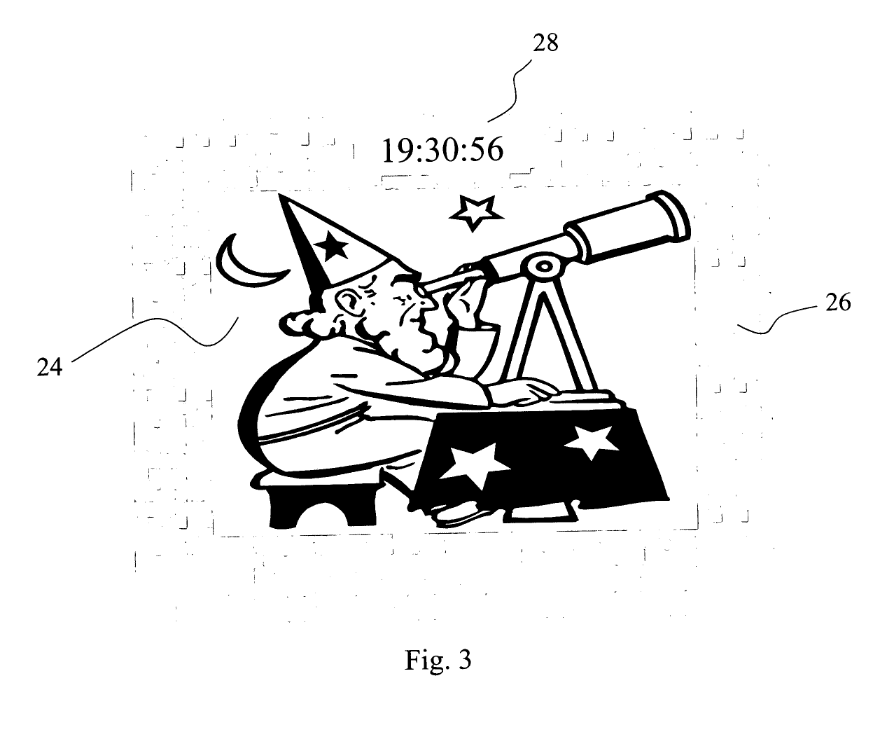

In another embodiment of the present invention, a time unit is added in the digital photo frame to generate the present time and date. The present time information 28 can be displayed on the display unit 12, especially displayed on the digital outer frame pattern 26, as shown in FIG. 3. Through the control software 16, the time display format can be selected, e.g., in a digital form or an analog form. When the present time information are displayed in an analog form, the time hands can be directly displayed above a picture with the picture as the background. Or the analog clock can be designed to be semi-transparent and displayed above the picture. The time unit 22 can also have an alarm clock function. A user can set a specific time himself. When the set time is arrived, the music stored in the storage unit 14 will be played as the alarm music. This alarm music can also be selected and set by the user himself. In addition to the time unit 22, a radio reception unit can also be added to receive radio signals played by the sound reception and playback unit 18. When the radio function of the digital photo frame is activated, the radio channel information can be displayed through the display unit 12 of the digital photo frame. The display position can be the original position for displaying the time information in a digital form. The control software 16 can be used to switch between the time or radio channel information.

Picture and music data stored in the storage unit 14 can be changed and renewed through memory cards and a computer or other storage media. An I/O interface (e.g., a universal serial bus (USB)) can also be provided in the digital photo frame for file transmission with a computer so that a user can conveniently transmit picture and music data already edited on the computer into the storage unit 14 of the digital photo frame.

To sum up, the present invention integrates many added functions into a conventional digital photo frame having only the picture displaying function. Through setting a matching music for each picture and the form of the digital outer frame, recording the matching music, and providing the time displaying function and the radio function by a user himself, the usage of the digital photo frame is much enhanced.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A digital photo frame comprising:
a storage unit for storing picture and music data;
a digital processing unit for processing picture and music data in said storage unit;
a display unit for displaying picture data processed by said digital processing unit and digital outer frame patterns of said digital photo frame;
a sound reception and playback unit used to receive sound and play music and convert the received sound into digital music data through said digital processing unit, said sound reception and playback unit being also used to store said digital music data into said storage unit and play music data processed by said digital processing unit;
a control software stored in said storage unit and executed by said digital processing unit, said control software being used to select a picture to be displayed from said storage unit and set a matching music for each picture and automatically play the matching music according to the displayed picture, said control software being also used to let a user select said digital outer frame pattern of said digital photo frame to be displayed; and
a control input unit letting a user be capable of operating said control software to control said digital photo frame, said control input unit being composed of at least more than one key located on said digital photo frame.

2. The digital photo frame as claimed in claim 1, wherein said storage unit is a flash memory.

3. The digital photo frame as claimed in claim 1, wherein said storage unit is a memory card access device, which can access CF cards, MS cards, MMC cards, SM cards, SD cards and XD cards.

4. The digital photo frame as claimed in claim 3, wherein said memory card access device can access microdrives.

5. The digital photo frame as claimed in claim 1, wherein said storage unit comprises a read only memory, and said control software is stored in said read only memory.

6. The digital photo frame as claimed in claim 1, wherein said display unit is a liquid crystal display, a plasma display panel, an organic light emitting device or a field emission device.

7. The digital photo frame as claimed in claim 1, wherein said sound reception and playback unit is composed of a microphone and a loudspeaker.

8. The digital photo frame as claimed in claim 1, wherein said digital photo frame further comprises an I/O interface for file transmission with a computer.

9. The digital photo frame as claimed in claim 8, wherein said I/O interface is a universal serial bus.

10. The digital photo frame as claimed in claim 1, wherein said music data are of the WAV or MP3 format.

11. The digital photo frame as claimed in claim 1, wherein said picture data are of the JPEG or GIF format.

12. The digital photo frame as claimed in claim 1, wherein the matching music are said digital music data recorded by said sound reception and playback unit when displaying different pictures through said control software.

13. The digital photo frame as claimed in claim 1, wherein a user can select a matching digital outer frame pattern for each picture through said control software, and said matching digital outer frame patterns can be automatically displayed according to displayed pictures.

14. A digital photo frame comprising:
a storage unit for storing picture and music data;
a digital processing unit for processing picture and music data in said storage unit;
a display unit for displaying picture data processed by said digital processing unit and digital outer frame patterns of said digital photo frame;
a sound playback unit used to play music data processed by said digital processing unit;
a control software stored in said storage unit and executed by said digital processing unit, said control software being used to select a picture to be displayed from said storage unit and set a matching music for each picture and automatically play the matching music according to the displayed picture, said control software being also used to let a user select said digital outer frame pattern of said digital photo frame to be displayed;
a clock unit for generating the present time information, which can be displayed through said display unit; and
a control input unit letting a user be capable of operating said control software to control said digital photo frame.

15. The digital photo frame as claimed in claim 14, wherein said clock unit has an alarm clock function, and said clock unit can set a specific time for playing music through said sound playback unit.

16. The digital photo frame as claimed in claim 14, wherein said picture data and said present time information can be simultaneously displayed on said display unit.

17. The digital photo frame as claimed in claim 14, wherein said present time information are displayed on said digital outer frame pattern to form part of said digital outer frame pattern.

18. The digital photo frame as claimed in claim 14, wherein said present time information are displayed in an analog or a digital form.

19. The digital photo frame as claimed in claim 18, wherein said present time information displayed in an analog form can be displayed above a picture displayed on said digital photo frame with said displayed picture as the background.

20. The digital photo frame as claimed in claim 14, wherein said digital photo frame further comprises a radio reception unit for selecting a radio channel through said control software and playing the radio through said sound playback unit.
